(19) United States
(12) Patent Application Publication
(10) Pub. No.: US 2002/0089747 A1
(43) Pub. Date: Jul. 11, 2002

(54) Techniques for reducing observed glare by using polarized optical transmission & reception devices

(76) Inventor: Ranald Joseph Hay, New York, NY (US)

Correspondence Address: Steven R. Bartholomew, Hopgood, Calimafde, Judlowe & Mondolino, Lincoln Bldg., 60 E. 42nd St., Suite 4100, New York, NY, 10165, US

(21) Appl. No.: 09/756,898

(22) Filed: Jan. 9, 2001

(51) Int. Cl. G02B 5/30; G02B 27/28

(52) U.S. Cl. 359/493; 359/485; 359/500; 359/601

(57) ABSTRACT

A visibility-enhancing system includes an adjustment mechanism for adjusting the polarization of a light source relative to the polarization of a viewing filter, so as to improve visual contrast between interposing media and an object to be viewed. The light source includes a light generation mechanism for generating polarized light, and an optional source polarization angle determination mechanism for adjusting the angle of polarization of the light source. The viewing filter includes a filter polarization angle adjustment mechanism for adjusting at least one of the polarization angle of maximum light attenuation and the polarization angle of minimum light attenuation. An observer adjusts at least one of the source polarization angle determination mechanism and the filter polarization angle adjustment mechanism so as to improve the visibility of the object to be viewed in the presence of interposing media.

### FIELD OF THE INVENTION

The present invention relates generally to the field of optics, and, more specifically, to devices and techniques for controlling reflected glare.

### BACKGROUND ART

Driving towards the sun, an icy road is transformed into a sea of fire. Droplets from a passing rainstorm produce a blinding glare across the windshield, obscuring lane markings and objects at the side of the road. A thick fog rolls in across the valley, and headlights from oncoming vehicles generate an opaque wall of white iridescence. These are all examples of uncontrolled light glare, which is quite abundant in nature.

In addition to driving, light glare is a problem in many other settings. Glare from reflective surfaces can impede the progress of jewelers working on intricate details. Glare also causes problems with certain types of surveillance equipment. Night vision devices use a source of infrared radiation to illuminate objects for viewing. A sensitive infrared receiving element is designed to handle the relatively low levels of infrared radiation that are reflected back to the night vision device. However, glare from reflective bright surfaces, such as glass, may overload the sensitive infrared receiving element, causing momentary “glare blindness” that lasts for as long as several seconds. These illuminators are often utilized in critical operational environments, such as law enforcement and national defense, where a delay of a few seconds could have devastating and far-reaching consequences.

From an analytical standpoint, light may be conceptualized as a particle or as a wave. However, when studying the problem of glare, it is useful to consider the wavelike aspect of light. These waves are made up of electrical and magnetic fields, oscillating at right angles to each other and at right angles to the direction in which the light is traveling. Most light, irrespective of whether it is produced naturally or artificially, includes electric field components situated in virtually all directions perpendicular to the direction of propagation.

By way of example, if the sun is on the Western horizon, the light it sheds toward the East will have electric fields oscillating up and down, north and south, and every direction in between. Such light is termed “unpolarized” light. Next, suppose that the sun is somewhat above the Western horizon, with a smooth water surface at the ground. Some of the light will penetrate into the water, and some light will be reflected. But if one examines this situation in more detail, an interesting phenomenon is observed. The electric fields that are oscillating in a direction across the surface of the water (in the present example, in a north-south direction) have trouble penetrating the water and are mostly reflected. At the same time, electric fields that are at least partially perpendicular to the water penetrate easily and produce only a little reflection. As a result, both the reflected light, as well as the light entering the water, become “polarized”.

Polarization simply refers to the fact that the electric field component of the light lies substantially in one plane. In other words, the light is dominated by waves having the same direction of electric field oscillation. Most of the light reflected from a horizontal surface will have an electric field that lies in a horizontal plane. Accordingly, it is said that such light is horizontally polarized. Ice, glass, or any other smooth surface that does not conduct electricity (or that is a poor conductor) behaves in much the same way as the above-described horizontal surface, with one notable exception. These smooth surfaces are not necessarily oriented horizontally, and so the light that they reflect will be polarized, but not necessarily in a horizontal direction. Such smooth objects are said to provide specular reflections. Metals, which conduct electricity, do not polarize light on reflection.

The concept of polarization may be advantageously exploited to develop devices for reducing glare. As a matter of fact, many existing devices are based upon the foregoing observation that smooth surfaces will reflect certain polarizations of light much more efficiently than other polarizations. A polarized filter can be oriented so as to attenuate these polarized reflected components, while, at the same time, allowing other light to pass through. For instance, polarized sun glasses are used to reduce unwanted glare from roadways and from snow.

Other devices which polarize light in order to reduce glare are known. For instance, U.S. Pat. No. 3,876,285 issued to Schwarzmüller, describes a polarization device for a vehicle's headlamps to reduce “dazzle” in the eyes of on-coming traffic. This device and similar devices involve the transmission of polarized light at a fixed, non-adjustable polarization. Schwarzmuller is directed to solving an efficiency problem whereby, if a conventional polarizing screen is placed in front of a source of unpolarized light, the light intensity will be reduced by about one-half. Schwarzmuller changes the polarization of the component that would normally be filtered out and recombines it with the filtered light, so as to provide a light beam that is not substantially reduced in intensity over the original unfiltered beam. However, no mechanism is provided to readily adjust the direction of polarization of the transmitted light. In addition, no mechanism is provided to adjust the polarization of light to be filtered out at the observers's eyes. Finally, this system is limited in application to automotive headlamps and the like, and is not adaptable to solving a broader range of light glare problems.

### OBJECTS AND SUMMARY OF THE INVENTION

It is an object of the present invention to provide a glare controlling apparatus to adjust the visible contrast of glare and re-emitted light from objects onto which light is shed.

Another object of the present invention is to provide a glare controlling apparatus which selectively controls the glare from interposing media such as rain and fog, to enhance the visible contrast between (a) objects onto which light is being shed, such as a vehicle in the distance, and (b) rain, snow, and/or fog.

The above and other objects of the invention are realized in the form of an improved visibility-enhancing system that includes an adjustment mechanism for adjusting the polarization of a light source relative to the polarization of a viewing filter, so as to improve visual contrast between interposing media and an object to be viewed. The light source includes a light generation mechanism for generating polarized light, and an optional source polarization angle determination mechanism for adjusting the angle of polarization of the light source. The viewing filter includes a filter polarization angle adjustment mechanism for adjusting at least one of the polarization angle of maximum light attenuation and the polarization angle of minimum light attenuation. An observer adjusts at least one of the source polarization angle determination mechanism and the filter polarization angle adjustment mechanism so as to improve the visibility of the object to be viewed in the presence of interposing media.

The polarized light source, when made to shine through interposing media such as water droplets, will ordinarily refract and reflect from individual droplets in a specular manner, such that the reflected light will be polarized at a substantially constant angle. These water droplets may represent, for example, fog, snow, and/or rain. The reflections are specular, irrespective of whether the droplets are in liquid, vaporous, vaporous aerosol, crystallized, and/or frozen form. Vaporous aerosols may refer to fog, steam, sprays, mists, and the like. On the other hand, light returning from objects in the distance will comprise both polarized and randomly polarized components from refraction, such that the specular component of the reflected light is not of relatively high magnitude. Adjustment of the angle of polarization of the light source relative to the angle of absorption of the polarization filter permits none, some, or all of the polarized light to be absorbed, as desired, controlling the relative brightness of non-specular objects in the distance (i.e., cars, telephone poles, trees) relative to the brightness of the glare from specular objects such as rain, fog, and snow.

Pursuant to a further embodiment of the invention, the polarized light source, when made to shine against shiny reflective objects such as glass or chrome plated objects, will ordinarily reflect strongly from the surface, obscuring other objects of interest. Such strongly reflected light can cause temporary “glare blindness” in night vision infrared amplifier tubes, or cause distracting highlights for the jeweler. It is known that polarized light reflecting from bright reflective nonconductive surfaces will retain a constant angle of polarization. Adjustment of the angle of polarization of the light source relative to the angle of absorption of the polarization filter permits polarized highlights reflected by shiny objects to be absorbed by the filter, thus greatly enhancing visual clarity.

According to an alternate embodiment of the invention, the angle of polarization of a light source is adjusted relative to the angle of absorption of a given surface onto which the emitted light shines. This technique permits adjustment of the proportion of the emitted light to be absorbed into the surface, greatly controlling the proportion of light which the surface will reflect back to a viewer as glare. The present embodiment may or may not be utilized in conjunction with a polarization-adjustable viewing filter. Illustratively, such a system may be employed to reduce glare from street lamps and airport runway lamps, and also for controlling glare in photographic, cinematic and display applications.

### BRIEF DESCRIPTION OF THE DRAWINGS

The foregoing features of the present invention may be more fully understood from the following detailed description of specific illustrative embodiments thereof, presented hereinbelow in conjunction with the accompanying drawings, in which:

FIG. 1 is a diagrammatic representation of a preferred embodiment of the invention.

FIGS. 2A and 2B are diagrammatic representations setting forth, respectively, a prior art illumination technique and an illumination technique pursuant to a first alternate embodiment of the invention.

FIG. 3 is a diagrammatic representation of a second alternate embodiment of the invention for use in the context of night vision equipment.

### DETAILED DESCRIPTION OF THE PREFERRED EMBODIMENTS

In overview, the invention is directed to a visibility-enhancing system that includes an adjustment mechanism for adjusting the polarization of a light source relative to the polarization of a viewing filter, so as to improve visual contrast between interposing media and an object to be viewed. The light source includes a light generation mechanism for generating polarized light, and an optional source polarization angle determination mechanism for adjusting the angle of polarization of the light source. The viewing filter includes a filter polarization angle adjustment mechanism for adjusting at least one of the polarization angle of maximum light attenuation and the polarization angle of minimum light attenuation. An observer adjusts at least one of the source polarization angle determination mechanism and the filter polarization angle adjustment mechanism so as to improve the visibility of the object to be viewed in the presence of interposing media.

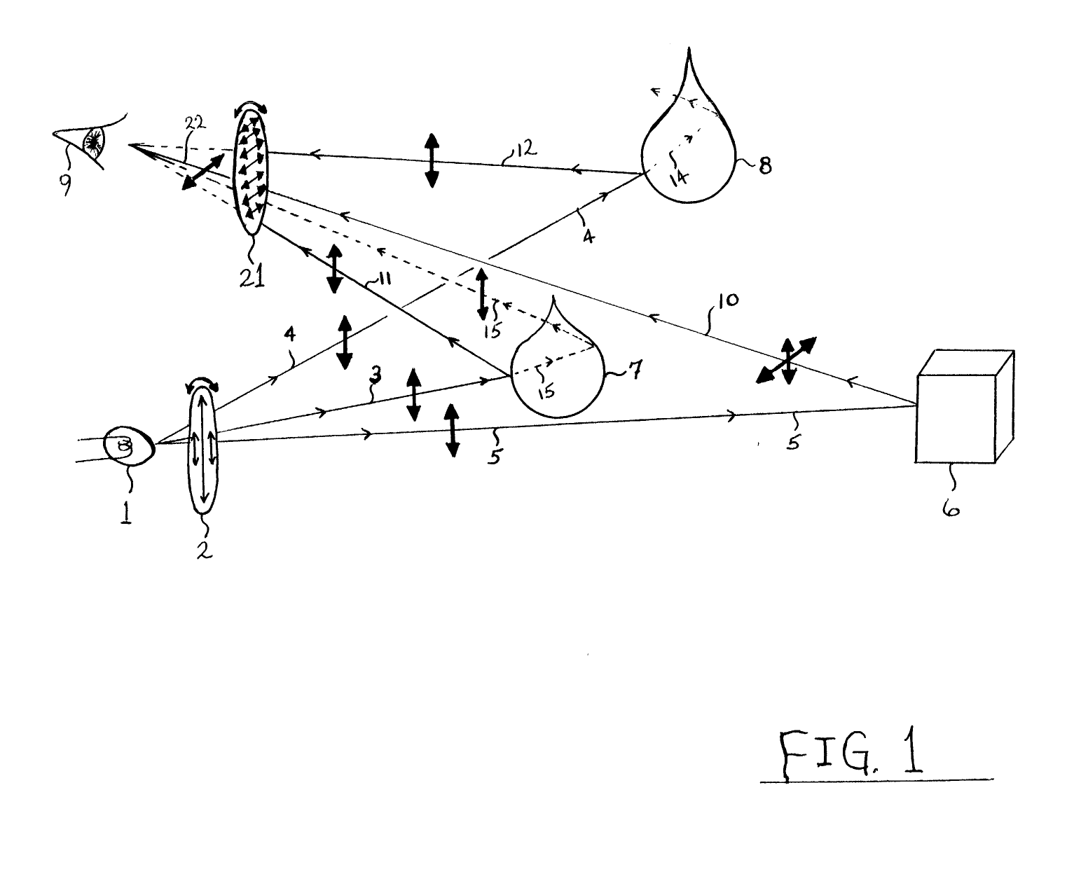

Refer now to FIG. 1 which is a diagrammatic representation of a preferred embodiment of the invention. A light source includes a light generation mechanism in the form of incandescent lamp 1. However, an incandescent lamp is shown for illustrative purposes, as any of a wide variety of light sources could be employed, including, for example, halogen lamps, flourescent lights, laser beams, and others. If the light generation mechanism emits nonpolarized light, then the light source includes, and/or is coupled to, a filtering mechanism for transforming the nonpolarized light into polarized light. The light source may also include, and/or be coupled to, an optional source polarization angle determination mechanism for adjusting the angle of polarization of the light source. The source polarization angle determination mechanism may, but need not, be combined with the filtering mechanism, as is shown in FIG. 1. Moreover, any combination of discrete or distributed elements may be utilized to implement the light source, the filtering mechanism, and the optional polarization angle determination mechanism. Illustratively, all of the aforementioned functionalities could be implemented by a single element, such as a rotatable laser beam, or each of these functionalities could be provided by discrete elements.

In the example of FIG. 1, the filtering mechanism and the optional polarization angle determination mechanism are provided in the form of an adjustable polarization screen 2. Unpolarized light from incandescent lamp 1 traverses adjustable polarization screen 2, thereby providing polarized light. The screen of FIG. 1 is adjusted such that this polarized light will be vertically polarized for purposes of illustration. A first vertically polarized light ray 3 travels from polarization screen 2 to a first specularly-reflecting object, shown here as a first water droplet 7. A portion of light ray 3 never enters water droplet 7, as it is reflected from the air-droplet interface as reflected light ray 11. It is important to note that reflected light ray 11 retains the same polarization as incident light ray 3. Since light ray 3 is vertically polarized, light ray 11 is also vertically polarized.

In general, not all of the incident light ray 3 is reflected by the air-droplet interface. A portion of the incident light ray 3 is refracted by the air-droplet interface and enters droplet 7 as light ray 15. Light ray 15 traverses droplet 7 until it encounters a droplet-air interface, whereupon a portion of light ray 15 is then reflected by this droplet-air interface back into the droplet 7. Upon encountering another droplet-air interface, a portion of light ray 15 is refracted and emerges from droplet 7 back into air. Throughout these reflections and refractions, light ray 15 retains its sense of polarization. Accordingly, when light ray 15 exits droplet 7, it is vertically polarized. Vertically polarized reflected light ray 11 and vertically polarized refracted light ray 15 travel towards an observer 9.

An adjustable viewing filter 21 intercepts light rays 11 and 15 before these light rays reach observer 9. In the example of FIG. 1, the adjustable viewing filter 21 has been adjusted so as to permit the passage of horizontally polarized light, and so as to substantially attenuate the passage of vertically polarized light. Since light rays 11 and 15 are both vertically polarized, these rays are substantially attenuated by adjustable viewing filter 21. Accordingly, the magnitudes of light rays 11 and 15, as reflected and/or refracted from droplet 7, are substantially reduced from the standpoint of observer 9.

A second vertically polarized light ray 4 travels from polarization screen 2 to a second specularly-reflecting object, shown here as a second water droplet 8. A portion of light ray 4 never enters water droplet 8, as it is reflected from the air-droplet interface as reflected light ray 12. It is important to note that reflected light ray 12 retains the same polarization as incident light ray 4. Since light ray 4 is vertically polarized, light ray 12 is also vertically polarized.

In general, not all of the incident light ray 4 is reflected by the air-droplet interface. A portion of the incident light ray 4 is refracted by the air-droplet interface and enters droplet 8 as light ray 14. Light ray 14 traverses droplet 8 until it encounters a droplet-air interface, whereupon a portion of light ray 14 is then reflected by this droplet-air interface back into the droplet 8. Upon encountering another droplet-air interface, a portion of light ray 14 is refracted and emerges from droplet 8 back into air. Throughout these reflections and refractions, light ray 14 retains its sense of polarization. When light ray 14 exits droplet 8, it is vertically polarized. However, unlike the situation with first water droplet 7, light ray 4 strikes a lower surface of water droplet 8, thereby providing angles of reflection and refraction that do not result in a return of refracted and reflected light ray 14 back towards observer 9. Accordingly, only vertically polarized reflected light ray 12, and not vertically polarized refracted light ray 14, travels toward observer 9.

An adjustable viewing filter 21 intercepts light ray 12 before this light ray reaches observer 9. In the example of FIG. 1, the adjustable viewing filter 21 has been adjusted so as to permit the passage of horizontally polarized light, and so as to substantially attenuate the passage of vertically polarized light. Since light ray 12 is vertically polarized, this ray is substantially attenuated by adjustable viewing filter 21. Accordingly, the magnitude of light ray 12, as reflected and/or refracted from droplet 8, is substantially reduced from the standpoint of observer 9.

A third vertically polarized light ray 5 travels from polarization screen 2 to a first nonspecularly reflecting object, shown here as object 6. In practice, object 6 could represent virtually any object to be observed by observer 9, such as an automobile, a train, a person, an animal, a workpiece, a sign, an airplane, a radio tower, a runway, a road surface, a lane marking, or others. In many cases, it is desired to enhance observed visual contrast between object 6 and intervening obstructive media, such as water droplets 7 and 8. This enhancement is brought about through a realization that most objects to be viewed do not reflect light in the same manner as obstructive media, such as, for example, water droplets. Although light ray 5, as incident upon object 6, is vertically polarized, this polarization is not retained upon reflection. When object 6 reflects light ray 5, the reflected light ray 10 is randomly polarized, and includes both vertical and horizontal polarization components. It is important to note that reflected light ray 10 does not retain the same polarization as incident light ray 5.

Randomly polarized reflected light ray 10 travels toward observer 9. An adjustable viewing filter 21 intercepts light ray 10 before this light ray reaches observer 9. In the example of FIG. 1, the adjustable viewing filter 21 has been adjusted so as to permit the passage of horizontally polarized light, and so as to substantially attenuate the passage of vertically polarized light. Since light ray 10 includes both vertical and horizontal polarization components, only the vertical component is substantially attenuated by adjustable viewing filter 21.

A substantial portion of the horizontal polarization component of light ray 10 passes through adjustable viewing filter 21 towards observer 9. Accordingly, the magnitude of light ray 10 reflected from object 10 is not attenuated by adjustable viewing filter 21 to the same degree as the magnitudes of rays 11, 12, and 15 reflected from water droplets 7 and 8. The magnitudes of light rays 11, 12, and 15, as reflected and/or refracted from droplet 7, are substantially reduced from the standpoint of observer 9. Adjustable filter 21 weakens rays 11, 12, and 15 by a much greater amount than it weakens ray 10 reflected by object 6. Accordingly, the visual contrast between object 6 and water droplets 7 and 8 is enhanced.

The alignment of polarization screen 2 to a vertical polarization and the alignment of adjustable viewing filter 21 to a horizontal polarization is shown for purposes of illustration. Pursuant to one embodiment of the invention, both the polarization screen 2 and viewing filter 21 are adjustable. However, pursuant to a first alternate embodiment, only one of the aforementioned elements—either the polarization screen 2 or the viewing filter 21—is made to be adjustable, and the remaining element is made to be nonadjustable. This alternate embodiment would be useful, for example, in the context of automobile design. An adjustable polarization screen 2 would be provided at the vehicle's headlamps, and the viewing filter 21 would be provided in the form of a nonadjustable windshield light polarization filter. Instead of, or in addition to, providing a windshield light polarization filter, the viewing filter could be provided at a rearview and/or sideview mirror, either in adjustable or nonadjustable form.

All that is required is some mechanism for adjusting the polarization of emitted light relative to that of light to be observed. In the example of FIG. 1, both polarization screen 2 and viewing filter 21 are adjustable, thereby providing an enhanced degree of flexibility. But, irrespective of whether one or both of these elements are adjustable, the polarization of emitted light is adjusted relative to that of light to be observed. This adjustment is performed so as to reduce perceived “glare” returning from specular intervening objects, such as water droplets, and/or to enhance visibility of nonspecular objects to be viewed. When this adjustment is properly implemented, a substantial portion the light perceived as “glare” returning from droplets (7) and (8) will be absorbed by viewing filter 21, thus increasing the relative visibility of light reflected from object 9. Phenomena such as “white-outs ” and “fog blindness”, which are actually caused by the presence of moisture (water droplets) in the air, can be greatly ameliorated, thereby increasing safety and visual acuity.

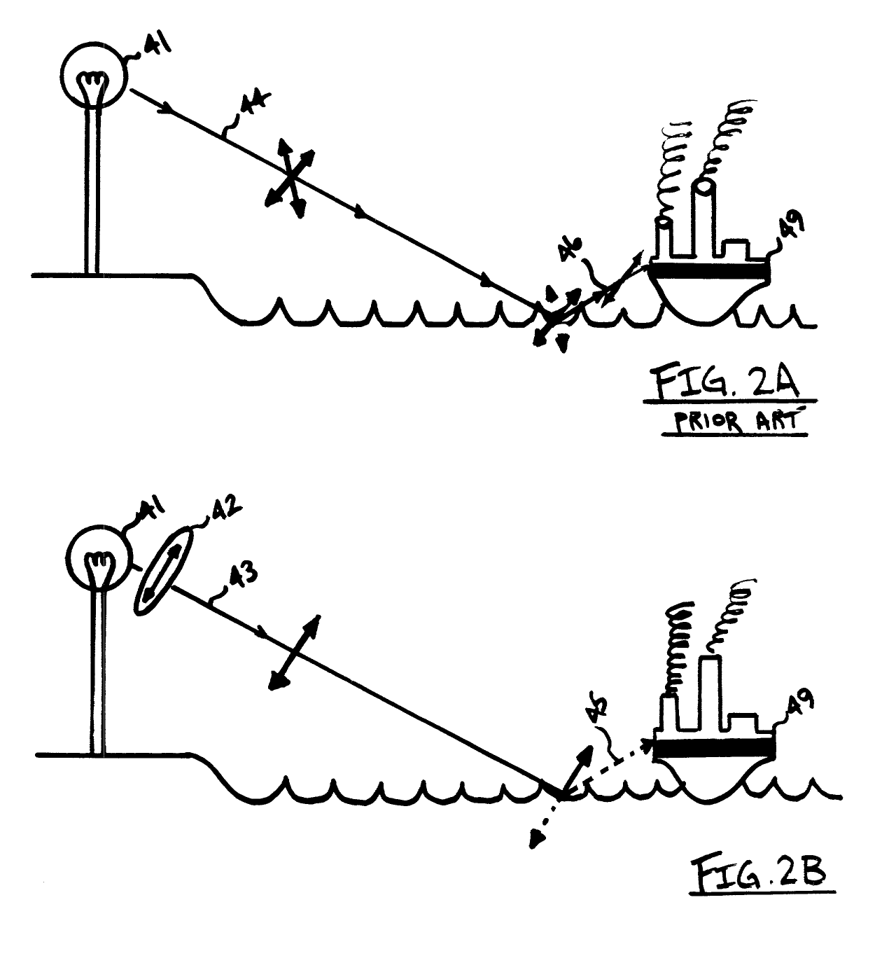

Refer, now to FIG. 2A, which is a diagrammatic representation setting forth a prior art illumination technique. A ship 49 is approaching an illumination source 41, which may represent one or more lights at a busy port terminal. Illumination source 41 includes one or more conventional incandescent, halogen, or flourescent lighting elements that emit randomly-polarized light. A randomly-polarized light ray 44, as emitted by illumination source 41, travels towards the surface of an ocean or lake. Upon striking the surface of the water, the vertical polarization components of light ray 44, which are effectively directed into the water surface, are substantially attenuated. However, the horizontal polarization components of light ray 44, which are effectively directed across the water surface, are substantially reflected. The reflected light ray, shown as light ray 46, is horizontally polarized. An observer at ship 49 will perceive this horizontally polarized component as glare across the water. This glare can greatly reduce visibility at ocean ports where a multiplicity of nonpolarized lights are in use. An analagous situation exists in the context of illuminated airport runways. In such operational environments, light is reflected from a damp concrete or asphalt surface, and not from an ocean or a lake. However, the remainder of the analysis is the same. Runway illumination lights reflect off of shiny, wet pavement surfaces, thereby causing glare and impeding visual acuity.

FIG. 2B is a diagrammatic representation setting forth an illumination technique pursuant to a first alternate embodiment of the invention. An illumination source 41 is provided with a polarization filtering mechanism 42. A discrete illumination source 41 and polarization filtering mechanism 42 is shown for purposes of conceptual illustration only, as the functionality of these two elements may be combined into a single element that provides polarized light without the need for a separate filtering element. The polarization filtering mechanism 42, and/or illumination source 41, are aligned such that the emitted light rays are substantially vertically polarized. Virtually all of the emitted rays could be vertically polarized. However, for certain system applications, it is only necessary to vertically polarize some of the emitted light rays. Only those rays that are expected to be directed towards water or pavement surfaces could be vertically polarized, with rays in other directions remaining randomly polarized, or being polarized in directions other than vertically. If the environment includes shiny or highly reflective surfaces that are not substantially horizontally oriented, the polarization of the emitted light towards such surfaces should be oriented perpendicularly to these surfaces, at least if this orientation is possible. In this manner, the polarization of the emitted light is optionally a function of horizontal angular position and/or vertical azimuth as referenced to illumination source 41.

Vertically polarized light ray 43 travels from polarization filtering mechanism 42 towards the surface of the ocean or lake. Upon striking this surface, most of the vertically polarized light is attenuated by the surface of the water, and very little light is reflected back along path 45 towards ship 49. Accordingly, an observer at ship 49 views little, if any, glare caused by illumination source 41 shining across the water.

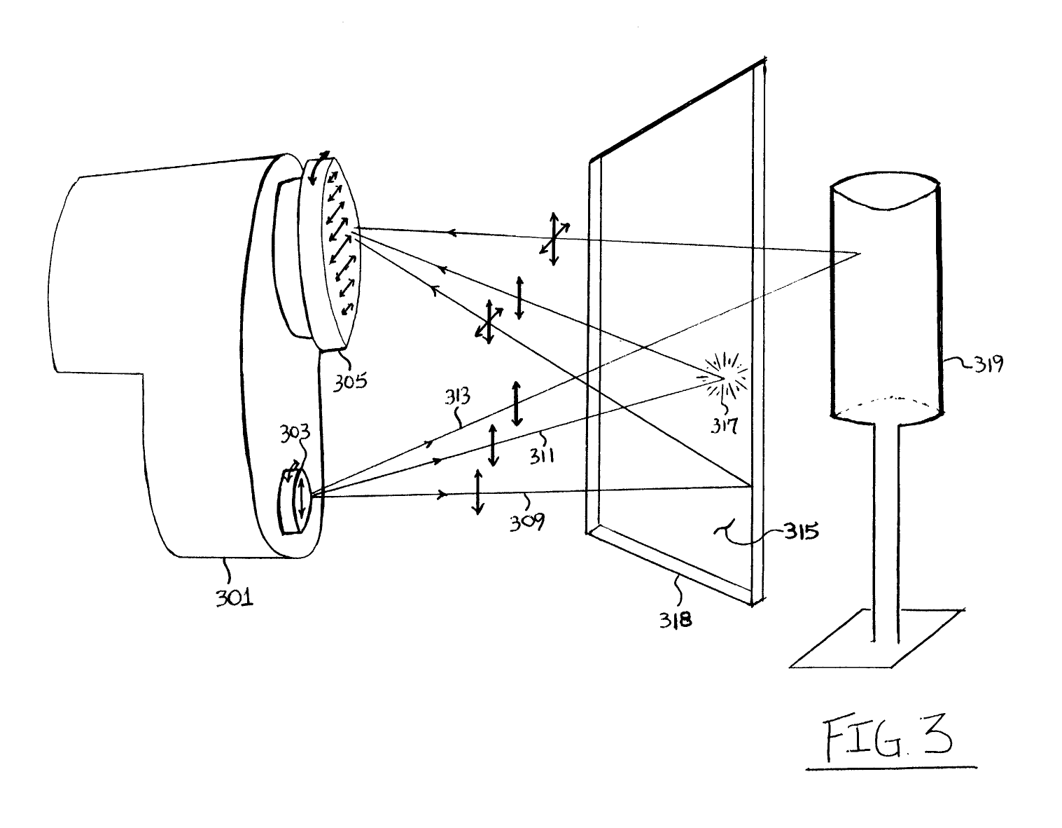

FIG. 3 is a diagrammatic representation of a second alternate embodiment of the invention for use in the context of night vision equipment. As a general matter, night vision equipment utilizes a source of infrared radiation for illuminating an area to be viewed. Some of the illuminated infrared radiation is reflected from objects in the viewing area back towards the night vision equipment. An optical detecting element in the night vision equipment detects this reflected radiation, thereby permitting an infrared image of the viewing area to be developed. Typically, this optical detecting element is a sensitive infrared detecting tube that is optimized to detect relatively low levels of infrared radiation. Such low levels of radiation would be reflected, for example, from a human observation target positioned in the area to be viewed. The detecting tube has a limited dynamic range, and it would be difficult or impossible to design such tubes to handle both very low and very high signal levels. High signal levels do not permanently damage the detecting tube, but they will overload the tube for a brief interval of one or two seconds.. During this overload period, detection of illuminated objects is not possible.

As long as there are not any objects in the field of view that would reflect very strong infrared signals back to the optical detecting element, the night vision equipment operates as it should. However, certain objects reflect infrared radiation much more efficiently than the human body. As a practical matter, glass, plastic, or plexiglass windows are highly efficient reflectors of infrared radiation. When the night viewing equipment illuminates such a window, the window returns a very strong infrared reflection back to the detecting tube, potentially overloading the tube for a few seconds. For hobbyists or casual users, this delay represents a minor annoyance. However, in the context of law enforcement, night viewing equipment is commonly used to aid in drug busts, for returning evasive fugitives to justice, and for repossessing foreclosed assets. These are critical situations where one or two seconds could make the difference between life and death.

The improved night viewing device 301 of FIG. 3 includes enhancements that substantially reduce the overload problem inherent in prior art designs. Night viewing device 301 includes a polarized infrared light source with a polarization adjustment mechanism 303. This functionality is illustratively provided by a discrete randomly-polarized infrared source optically coupled to a rotatable polarization screen, although other devices could alternatively be employed to provide the same or similar functionality. Night viewing device 301 also includes an infrared detecting element equipped with an adjustable polarization filter 305. As in the case of the aforementioned infrared source, the detecting element and adjustable polarization filter could be implemented using any combination of discrete and/or integrated elements.

To explain the operation of night vision device 301, assume that polarization adjustment mechanism 303 is adjusted so as to transmit vertically polarized infrared radiation. Also assume that adjustable polarization filter 305 is configured so as to permit detection of horizontally polarized infrared radiation. A first ray 311 of vertically polarized infrared radiation travels from polarization adjustment mechanism 303 to glass panel 315. A substantial portion of infrared radiation incident upon glass panel 315 is reflected from the glass panel and back to night vision device 301, also as vertically polarized infrared radiation. In the context of prior art designs, this reflection will cause glare 317, and it will also cause an overloading of the infrared detecting element.

In the design of FIG. 3, adjustable polarization filter 305 is adjusted to substantially admit horizontally polarized infrared radiation while, at the same time, substantially attenuating vertically polarized infrared radiation. As a result, polarization filter 305 shields the infrared detecting element from the strong reflections returned by glass panel 315. These reflections no longer overload the detecting element, and night vision device 301 will continue to operate normally. For example, a vertically polarized light ray 309 travels from polarization adjustment mechanism 303 to a frame 318 that encases glass panel 315. Frame 318 is illustratively fabricated from wood, painted metal, vinyl, plastic, and/or any of various other typical construction materials that provide nonspecular reflections. Accordingly, upon reflection from frame 318, light ray 309 becomes randomly polarized. Randomly-polarized light ray 309 travels towards polarization filter 305. At least a portion of the horizontal component of randomly-polarized light ray 309 is able to pass through polarization filter 305 to an infrared detecting element within night vision device 301, whereas the vertical component of randomly polarized light ray 309 is substantially attenuated by polarization filter 305. The admitted horizontal component permits night vision device 301 to provide an image of frame 318.

Similarly, a vertically polarized light ray 313 travels from polarization adjustment mechanism 303, through glass panel 315, and onwards to a nonspecular object 319. The polarization of light ray 313 is not affected by its traversal through glass panel 315, and the light ray 313, as incident upon object 319, is still vertically polarized. Object 319 represents any substantially nonspecular object, such as a person, an animal, an automobile, a vehicle, a tree, a plant, a projectile, a sign, or virtually any other object that does not provide substantially specular reflections. Upon reflection from nonspecular object 319, light ray 313 becomes randomly polarized. This randomly-polarized light ray 313 traverses through glass panel 315, with its random polarization substantially unchanged.

Randomly-polarized light ray 313 travels towards polarization filter 305. At least a portion of the horizontal component of randomly-polarized light ray 313 is able to pass through polarization filter 305 to an infrared detecting element within night vision device 301, whereas the vertical component of randomly polarized light ray 313 is substantially attenuated by polarization filter 305. The admitted horizontal component permits night vision device 301 to provide an image of object 319.

The above described arrangement is merely illustrative of the general principles of the present invention. Numerous modifications and adaptations thereof will be readily apparent to those skilled in the art without departing from the spirit and scope of the present invention.

We claim:

1. A system for enhancing visibility in the presence of interposing specular media, the system comprising:
(a) a light source including, or coupled to, a source polarization mechanism for generating polarized light that is substantially polarized at a light source polarization angle;
(b) an observation filter for filtering polarized light, the observation filter having a filter polarization angle of (i) substantially maximum light attenuation, or (ii) substantially minimum light attenuation; and
(c) a mechanism for adjusting the source polarization mechanism relative to the filter polarization angle, so as to improve visual contrast between an object to be viewed and interposing specular media.

2. The system of claim 1 wherein the interposing specular media comprise at least one of water droplets, ice, snow, fog, rain, sleet, hail, dust, dirt, metallic particles, and particles of sand.

3. The system of claim 2 wherein the light source polarization angle is substantially fixed, such that the mechanism for adjusting the source polarization mechanism relative to the filter polarization angle adjusts the filter polarization angle.

4. The system of claim 2 wherein the filter polarization angle is substantially fixed, such that the mechanism for adjusting the source polarization mechanism relative to the filter polarization angle adjusts the source polarization mechanism.

5. The system of claim 2 wherein the filter polarization angle is adjustable and the light source polarization angle is also adjustable, and the mechanism for adjusting the source polarization mechanism relative to the filter polarization angle adjusts both the source polarization mechanism and the filter polarization angle.

6. A method for enhancing visibility in the presence of interposing specular media, the method comprising the steps of:
(a) generating polarized light that is substantially polarized at a light source polarization angle;
(b) filtering polarized light with an observation filter having a filter polarization angle of (i) substantially maximum light attenuation, or (ii) substantially minimum light attenuation; and
(c) adjusting the source polarization angle relative to the filter polarization angle, so as to improve visual contrast between an object to be viewed and interposing specular media.

7. The method of claim 6 wherein the interposing specular media comprise at least one of water droplets, ice, snow, fog, rain, sleet, hail, dust, dirt, metallic particles, and particles of sand.

8. The method of claim 7 wherein the light source polarization angle is substantially fixed, such that the step of adjusting the source polarization angle relative to the filter polarization angle is performed by adjusting the filter polarization angle.

9. The method of claim 7 wherein the filter polarization angle is substantially fixed, such that the step of adjusting the source polarization angle relative to the filter polarization angle is performed by adjusting the source polarization angle.

10. The method of claim 7 wherein the filter polarization angle is adjustable and the light source polarization angle is also adjustable, and the step of adjusting the source polarization angle relative to the filter polarization angle is performed by adjusting both the source polarization angle and the filter polarization angle.

11. A system for enhancing visibility in the presence of a glare-producing surface, the system comprising:
(a) a light source including, or coupled to, a source polarization mechanism for generating polarized light that is substantially polarized at a light source polarization angle; and
(b) a mechanism for adjusting the source polarization mechanism relative to the glare-producing surface, so as to reduce the amount of light from the light source that is reflected by the glare-producing surface.

12. The system of claim 11 wherein the source polarization mechanism polarizes light at an angle within approximately thirty degrees of perpendicular to the glare-producing surface.

13. The system of claim 12 wherein the source polarization mechanism polarizes light at an angle substantially perpendicular to the glare-producing surface.

14. The system of claim 11 wherein the glare-producing surface is at least one of: the surface of a body of water, a concrete surface, an asphalt surface, and a surface of a building.

15. A method for enhancing visibility in the presence of a glare-producing surface, the method comprising the steps of:
(a) generating polarized light that is substantially polarized at a light source polarization angle; and
(b) adjusting the source polarization mechanism relative to the glare-producing surface, so as to reduce the amount of light from the light source that is reflected by the glare-producing surface.

16. The method of claim 15 wherein step (a) is performed such that the polarized light is polarized at an angle within approximately thirty degrees of perpendicular to the glare-producing surface.

17. The method of claim 16 wherein step (a) is performed such that the polarized light is polarized at an angle substantially perpendicular to the glare-producing surface.

18. The method of claim 15 wherein the glare-producing surface is at least one of: the surface of a body of water, a concrete surface, an asphalt surface, and a surface of a building.

19. An infrared-based system for enhancing night vision in the presence of an object that produces infrared glare, the system comprising:
(a) an infrared light source including, or coupled to, a source polarization mechanism for generating polarized light that is substantially polarized at a light source polarization angle;
(b) an observation filter for filtering polarized infrared light, the observation filter having a filter polarization angle of (i) substantially maximum infrared light attenuation, or (ii) substantially minimum infrared light attenuation; and
(c) a mechanism for adjusting the source polarization mechanism relative to the filter polarization angle, so as to improve visual contrast between an object to be viewed and the object that produces infrared glare.

20. The system of claim 19 wherein the light source polarization angle is substantially fixed, such that the mechanism for adjusting the source polarization mechanism relative to the filter polarization angle adjusts the filter polarization angle.

21. The system of claim 19 wherein the filter polarization angle is substantially fixed, such that the mechanism for adjusting the source polarization mechanism relative to the filter polarization angle adjusts the source polarization mechanism.

22. The system of claim 19 wherein the filter polarization angle is adjustable and the light source polarization angle is also adjustable, and the mechanism for adjusting the source polarization mechanism relative to the filter polarization angle adjusts both the source polarization mechanism and the filter polarization angle.

23. An infrared-based method for enhancing night visibility in the presence of an object that produces infrared glare, the method comprising the steps of.
(a) generating polarized infrared light that is substantially polarized at a light source polarization angle;
(b) filtering polarized infrared light with an observation filter having a filter polarization angle of (i) substantially maximum infrared light attenuation, or (ii) substantially minimum infrared light attenuation; and
(c) adjusting the source polarization angle relative to the filter polarization angle, so as to improve visual contrast between an object to be viewed and the object that produces infrared glare.

24. The method of claim 23 wherein the light source polarization angle is substantially fixed, such that the step of adjusting the source polarization angle relative to the filter polarization angle is performed by adjusting the filter polarization angle.

25. The method of claim 23 wherein the filter polarization angle is substantially fixed, such that the step of adjusting the source polarization angle relative to the filter polarization angle is performed by adjusting the source polarization angle.

26. The method of claim 23 wherein the filter polarization angle is adjustable and the light source polarization angle is also adjustable, and the step of adjusting the source polarization angle relative to the filter polarization angle is performed by adjusting both the source polarization angle and the filter polarization angle.
